(19) United States
(12) Patent Application Publication
(10) Pub. No.: US 2024/0123822 A1
(43) Pub. Date: Apr. 18, 2024

(54) CONTROLLING THE OPERATION OF AN AUTONOMOUS VEHICLE BASED ON DETECTED PASSENGER CHARACTERISTICS AND BEHAVIOR

(71) Applicant: Motional AD LLC, Boston, MA (US)

(72) Inventors: Jihoon Kim, Pittsburgh, PA (US); Jinsu Jeong, Pittsburgh, PA (US); Hyeongjin Ham, Pittsburgh, PA (US); Dongho Shin, Wexford, PA (US)

(21) Appl. No.: 18/090,073

(22) Filed: Dec. 28, 2022

Related U.S. Application Data
(60) Provisional application No. 63/416,488, filed on Oct. 14, 2022.

(51) Int. Cl. B60K 28/00; B60K 31/00; B60W 60/00

(52) U.S. Cl. CPC B60K 28/00; B60K 31/00; B60W 60/001; B60W 2420/42; B60W 2540/01; B60W 2540/043; B60W 2540/18; B60W 2540/20; B60W 2540/227; B60W 2720/10

(57) ABSTRACT

Provided are methods for controlling the operation of an autonomous vehicle based on detect passenger behavior, which can include receiving, by one or more processors, sensor data from one or more sensors regarding a passenger compartment of a vehicle; determining, by the one or more processors, and based on the sensor data, that an object entered a zone of the passenger compartment while the vehicle is in motion; and causing, by the one or more processors, a modification to an operation to the vehicle based on the determination that the object entered the zone of the passenger compartment while the vehicle is in motion. Systems and computer program products are also provided.

### CROSS-REFERENCE TO RELATED APPLICATIONS

The present application claims priority from U.S. Provisional Application No. 63/416,488, filed on Oct. 14, 2022, entitled “Virtual Fence,” which is herein incorporated by reference in its entirety.

### BACKGROUND

Vehicles can be used to transport people from one location to another. For example, a person can enter the passenger compartment of a vehicle and use the vehicle to travel to a destination (e.g., by instructing an autonomous system of the vehicle to navigate the vehicle to the destination).

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIGS. 5A and 5B are diagrams of certain components of a passenger detection system;

FIG. 5C is a diagram of an example process for controlling the operation of an autonomous vehicle.

FIG. 6A is a diagram of an implementation of a neural network;

FIGS. 6B and 6C are a diagram illustrating example operation of a CNN;

FIG. 7 is a flowchart of a process for controlling the operation of an autonomous vehicle based on detected passenger characteristics and behavior.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement controlling an operation of an autonomous vehicle based on detected passenger characteristics and behavior.

In an example implementation, a passenger detection system detects a passenger performing certain actions while an autonomous vehicle is moving. Example actions including entering a restricted zone of the passenger compartment (e.g., an region of the passenger compartment corresponding to the driver's area), introducing an object into the restricted zone, and/or manipulating the control mechanisms of the autonomous vehicle (e.g., steering wheel, pedals, turn signal lever, gear shift lever, wiper lever, etc.). In response, the passenger detection system modifies an operation of the autonomous vehicle. Example modifications include presenting a warning notification to the passenger, reducing the speed of the autonomous vehicle, turning on a hazard signal of the autonomous vehicle, and/or stopping the autonomous vehicle (e.g., by pulling over the autonomous vehicle on a side of a road).

In another example implementation, a passenger detection system detects the presence of a passenger in a particular seat of the autonomous vehicle, and determines whether the passenger is an adult or a child. Upon determining that the passenger is a child, the passenger detection system selectively disables certain control mechanisms that may be accessible by that passenger. As an example, the passenger detection system disables mechanisms for opening a door and/or a window near the passenger.

Some of the advantages of these implementations include increasing the safety of an autonomous vehicle. For example, a passenger detection system detects behavior by a passenger that may interfere with the safe of operation of the autonomous vehicle, and perform operations that reduce a risk of the autonomous vehicle being involved in a traffic conflict and/or reduce the risk that the passenger being injured.

For instance, although an autonomous vehicle can be configured for autonomous operations, the autonomous vehicle may still include control mechanisms (e.g., steering wheel, pedals, turn signal lever, gear shift lever, wiper lever, etc.) for manually operating the autonomous vehicle, such as in emergency situations, to facilitate maintenance, etc. The passenger detection system detects passengers interfering with the control mechanisms and/or entering a restricted zone of the autonomous vehicle where the control mechanisms may be physical accessed (e.g., the driver's seat), and performs operations that reduce the risk of the autonomous vehicle being involved in a traffic conflict and/or reduce the risk of the passenger being injured.

Further, a passenger detection system can be used in lieu of a physical barrier (e.g., a wall made from a solid material, such as plastic, polycarbonate, metal, etc.) to prevent a passenger from accessing a restricted zone of an autonomous vehicle, which may be undesirable in some implementations. For example, in some implementations, a physical barrier introduces a safety risk to a passenger (e.g., as the passenger may come into contact with the physical barrier during a sudden maneuver by the autonomous vehicle). As another example, in some implementations, a physical barrier reduces the seating capacity of the autonomous vehicle and/or reduce the space that is available to a passenger. Accordingly, an autonomous vehicle having a passenger detection system in lieu of a physical barrier operates more safely, provides increased seating capacity, and/or provides increased passenger comfort when compared to an autonomous vehicle that includes a physical barrier to protect a restricted zone. Nevertheless, in some implementations, a passenger detection system is used in combination with a physical barrier to prevent a passenger from accessing a restricted zone of an autonomous vehicle (e.g., to further protect the restricted zone of the autonomous vehicle during operation).

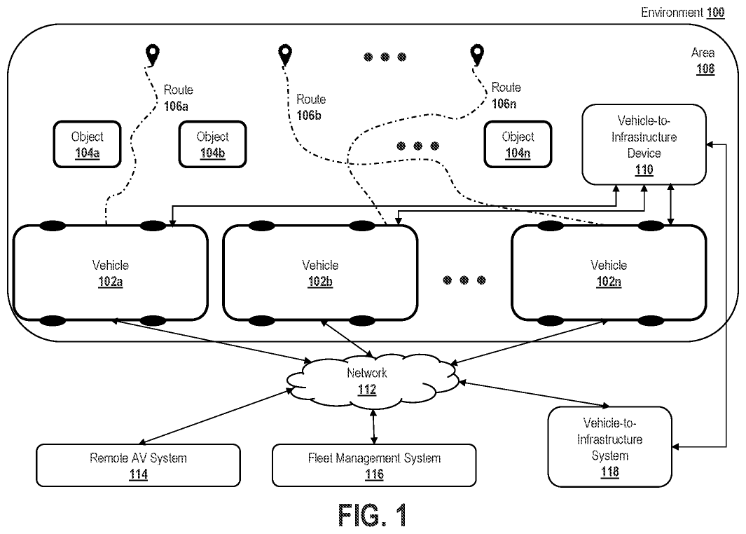

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

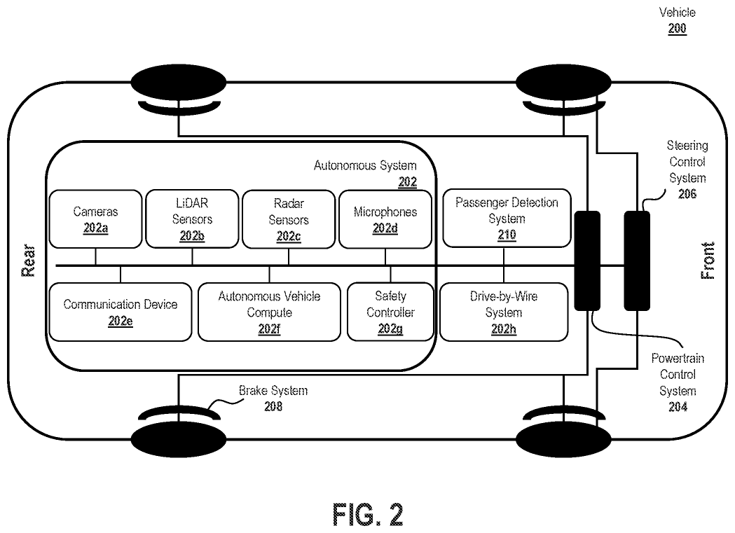

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, brake system 208, and a passenger detection system 210. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

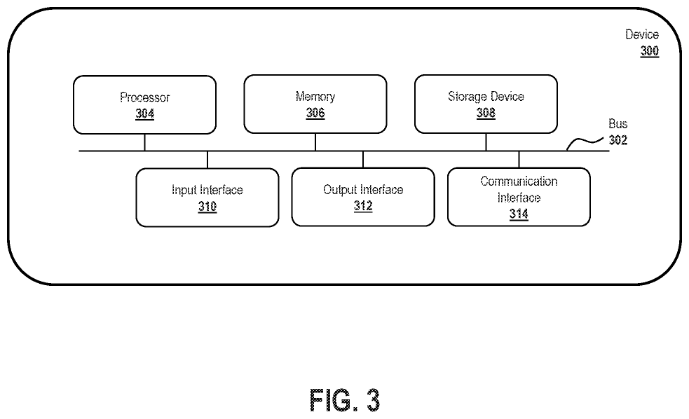

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, DBW (Drive-By-Wire) system 202h, and/or the passenger detection system 210. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Further, the passenger detection system 210 includes at least one device configured to detect the presence of a passenger within the passenger compartment of the autonomous vehicle, detect one or more characteristic that passenger, and/or detect one or more actions performed by that passenger. Further, the passenger detection system 210 includes at least one device configured to control the operation of the autonomous vehicle based on the detected passenger, characteristics, and/or actions.

As an example, the passenger detection system 210 detects a passenger performing certain actions while an autonomous vehicle is moving, such as entering a restricted zone of the passenger compartment (e.g., an region of the passenger compartment corresponding to the driver's area), introducing an object into the restricted zone, and/or manipulating the control mechanisms of the autonomous vehicle (e.g., steering wheel, pedals, turn signal lever, gear shift lever, wiper lever, etc.). In response, the passenger detection system 210 modifies an operation of the autonomous vehicle. Example modifications include presenting a warning notification to the passenger, reducing the speed of the autonomous vehicle, turning on a hazard signal of the autonomous vehicle, and/or stopping the autonomous vehicle (e.g., by pulling over the autonomous vehicle on a side of a road).

As another example, the passenger detection system 210 detects the presence of a passenger in a particular seat of the autonomous vehicle, and determines whether the passenger is an adult or a child. Upon determining that the passenger is a child, the passenger detection system 210 selectively disables certain control mechanisms that may be accessible by that passenger. As an example, the passenger detection system 210 disables mechanisms for opening a door and/or a window near the passenger.

In some embodiments, the passenger detection system 210 is implemented, at least in part, as one or more components of the autonomous system 202. In some embodiments, the passenger detection system 210 is implemented, at least in part, as one or more components or devices that are separate and distinct from the autonomous system 202.

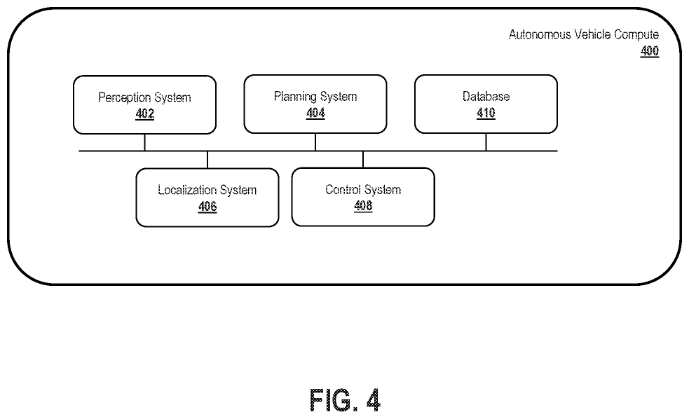

Further details regarding the passenger detection system 210 are described, for example, with reference to FIGS. 4-7.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or vehicle 200, and/or one or more devices of network 112 (e.g., one or more devices of a system of network 112). In some embodiments, one or more devices of vehicles 102 and/or 200 (e.g., one or more devices of a system of vehicles 102 and/or 200, such as the autonomous system 202, the passenger detection 210, etc.), remote AV system 114, fleet management system 116, V2I system 118, and/or one or more devices of network 112 (e.g., one or more devices of a system of network 112) include at least one device 300 and/or at least one component of device 300.

As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

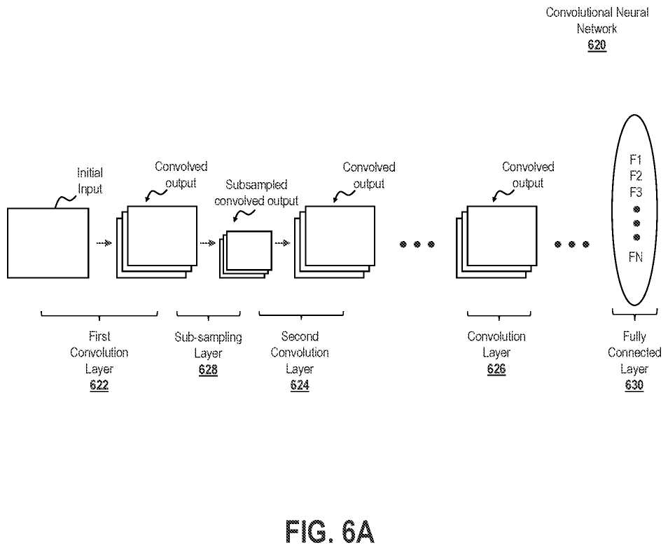

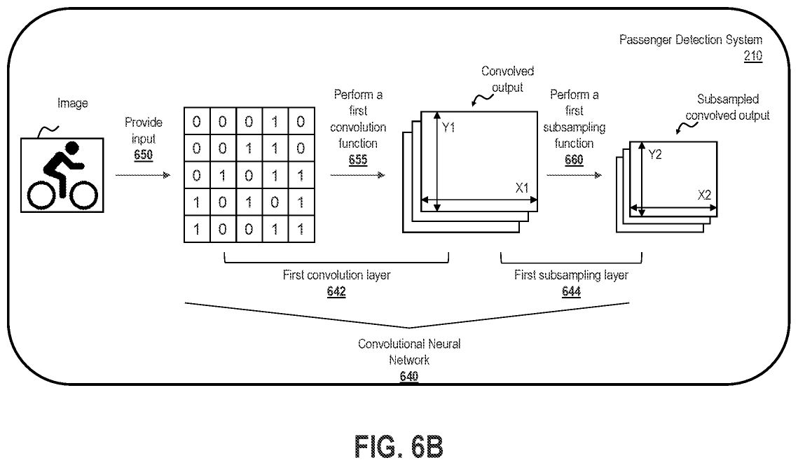

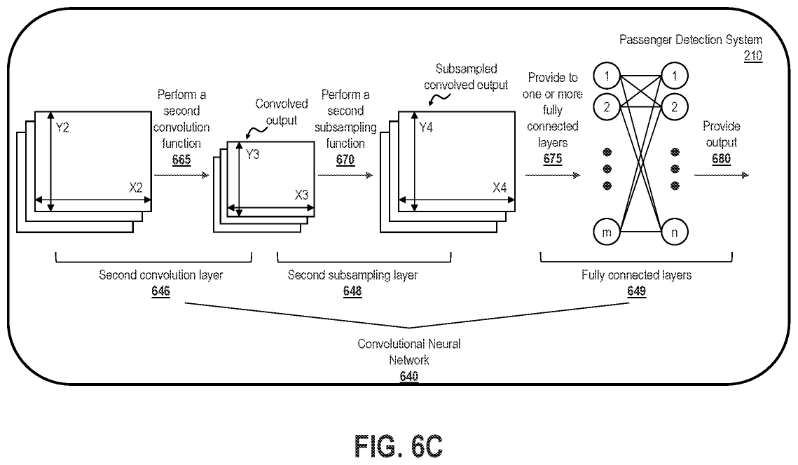

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 6A-6C.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

### Example Passenger Detection Systems

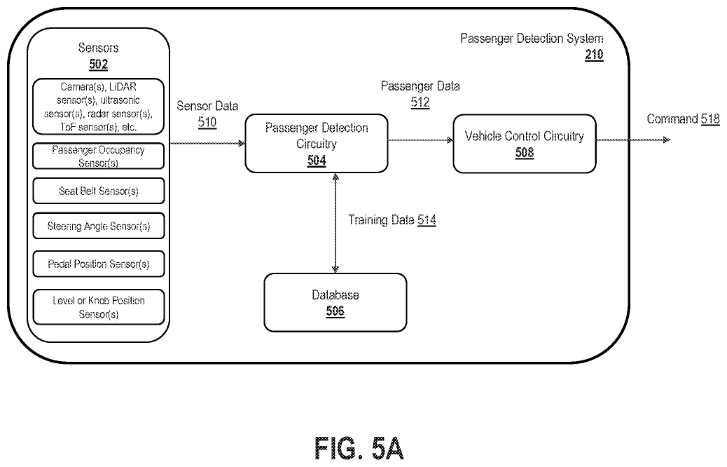

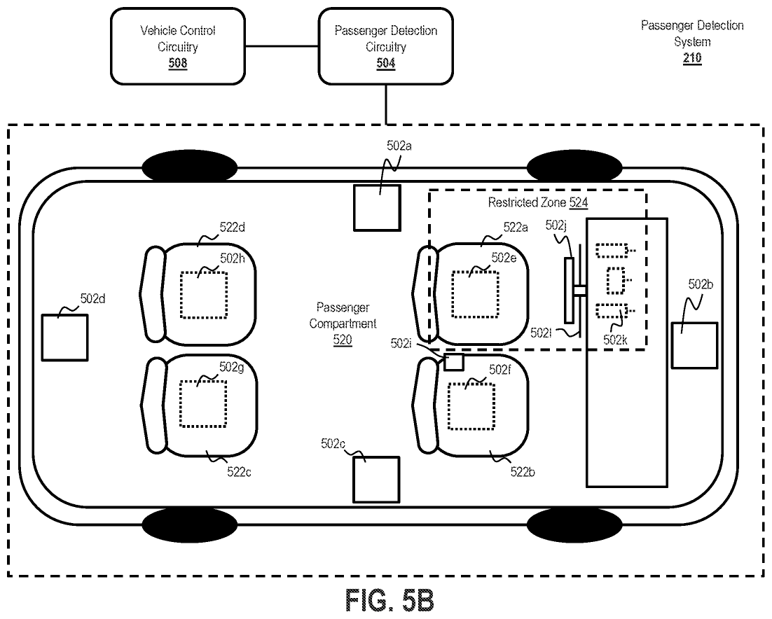

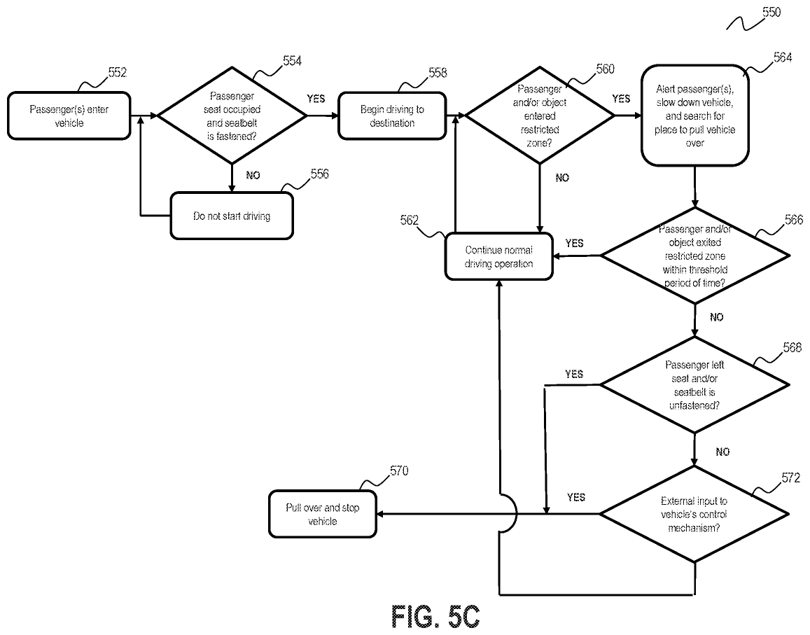

FIG. 5A shows aspects of the passenger detection system 210 in greater detail. The passenger detection system 210 includes one or more sensors 502, passenger detection circuitry 504, a database 506, and vehicle control circuitry 508.

In general, the passenger detection system 210 is configured to detect the presence of a passenger within a passenger compartment of an autonomous vehicle and/or detect one or more actions performed by the passenger. Further, the passenger detection system 210 is configured to control (e.g., modify) the operation of the autonomous vehicle based on the detection.

As an example, referring to FIG. 5B, several sensors 502a-502k are positioned along an interior of a passenger compartment 520 of an autonomous vehicle (e.g., an interior cabin of an autonomous vehicle that allows passengers to sit, stand, and/or lay down during the operation of the autonomous vehicle). Further, the sensors 502a-502k are configured to generate sensor data 510 representing the passenger compartment 520 and/or one or more subjects within the passenger compartment 520.

Referring again to FIG. 5A, in some implementations, the sensors 502 includes one or more cameras (e.g., still cameras, video cameras, cameras 202a of FIG. 2 etc.), LiDAR sensors (e.g., LiDAR sensors 202b of FIG. 2), ultrasonic sensors, radar sensors (e.g., radar sensors 202c of FIG. 2), time of flight sensors, and/or any other sensors configured to generate images, point clouds, or other representations of the passenger compartment 520 and/or subjects within the passenger compartment 520. As an example, as shown in FIG. 5B, the sensors 502a-502d are positioned at different respective positions within the passenger compartment 520, and is configured to generate images, point clouds, and/or other representations of the passenger compartment 520 and/or subjects within the passenger compartment 520.

In some implementations, the sensors 502 includes one or more passenger occupancy detection sensors configured to detect the presence of a passenger in one or more seats of the autonomous vehicle. As an example, as shown in FIG. 5B, an autonomous vehicle includes a driver seat 522a (e.g., a seat that is positioned such that its occupant can access the control mechanisms for manually controlling the autonomous vehicle's operations, such as a steering wheel, gear shift lever, turn signal lever, wiper lever, pedals, etc.). Further, the autonomous vehicle includes passenger seats 522b-522d (e.g., seats that are positioned away from the input mechanisms for manually controlling the autonomous vehicles operations). Each of the seats 522a-522d includes a respective sensor (e.g., a pressure sensitive sensor, piezoelectric sensor, etc.) that detects whether a particular amount of weight has been applied to the seat 522a-522d, and generates a signal representing the presence (or absence) of an individual or the weight on the seat 522a-522d. As an example, the sensors 502e-502h generates a first sensor signal when the weight is above a threshold weight (e.g., a threshold weight that is indicative of a passenger sitting that seat 522a-522d, respectively, such as a weight greater than or equal to 15 kg or 33 pounds). As another example, the sensors 502e-502h generate a different second sensor signal when the weight is less than or equal to the threshold weight.

Referring again to FIG. 5A, in some implementations, the sensors 502 includes one or more sensors 502i configured to detect whether one or more seat belts to the autonomous vehicle are secured relative to a passenger. As an example, one or more sensors are configured to determine, for each of the seat belts, whether a tongue of the seat belt is inserted and secured to its corresponding buckle or receptacle. A sensor generates a first sensor signal when a respective seat belt is secured to a passenger, and generate a different second sensor signal when that seat belt is not secured to a passenger.

In some implementations, the sensors 502 includes one or more sensors configured to determine whether an input (e.g., an external input) has been applied to the control mechanisms for manually controlling the autonomous vehicle's operations (e.g., by a passenger, object, etc.). For example, at least some of the sensors 502 are steering angle sensor(s) 502j configured to determine whether the steering wheel has been rotated and/or the degree to which the steering wheel has been rotated, and generate a sensor signal representing that determination. As another example, at least some of the sensors 502 are pedal position sensor(s) 502k configured to determine whether a pedal (e.g., a brake pedal, acceleration pedal, etc.) has been pressed and/or the degree to which the pedal has been pressed, and generate a sensor signal representing that determination. As another example, at least some of the sensors 502 are lever and/or knob position sensor(s) 5021 configured to determine whether another control mechanism (e.g., gear lever, wiper lever, turn signal lever, selector knob, etc.) has been manipulated, and generate a sensor signal representing that determination.

The sensor 502 generates sensor data 510 (e.g., images, point clouds, sensor signals, etc.), and transmits at least some of the sensor data 510 to the passenger detection circuitry 504 for further processing.

In general, the passenger detection circuitry 504 is configured to process the sensor data 510, and determine information regarding the characteristics and/or behavior of one or more passengers within the passenger compartment.

As an example, the passenger detection circuitry 504 is configured to determine, based on the sensor data 510, that a passenger is positioned at a particular location within the passenger compartment 520 (e.g., in a particular one of the seats 522a-522d, or elsewhere in the passenger compartment 520).

As another example, the passenger detection circuitry 504 is configured to determine, based on the sensor data 510, a classification or category of the passenger. For instance, the passenger detection circuitry 504 determines whether the passenger is an adult or a child. In some implementation, a child refers to passengers that are under a particular threshold age (e.g., 5, 6, 7, 8, 9, 10, or any other age), and an adult refers to a passenger that is greater than or equal to the threshold age. In some implementations, the threshold age is selected by a developer of the passenger detection system 210 and/or an administrator or operation of the autonomous vehicle (e.g., an operator or administrator of a ride-share provider).

As another example, the passenger detection circuitry 504 is configured to differentiate between different subjects in the passenger compartment. For instance, the passenger detection circuitry 504 determines whether a particular subject is a human, an animal, an inanimate object (e.g., an umbrella, briefcase, backpack, suitcase, bag, etc.), or some other object or entity.

As another example, the passenger detection circuitry 504 is configured to determine, based on the sensor data 510, whether a passenger is moving from one location of the passenger compartment 520 to another location. For instance, the passenger detection circuitry 504 determines whether a passenger is moving one seat 522a-522d to another seat 522a-522d. As another example, the passenger detection circuitry 504 determines whether a passenger has left her seat 522a-522d (e.g., by standing up or otherwise shifting from that seat).

As another example, the passenger detection circuitry 504 is configured to determine, based on the sensor data 510, whether a passenger has entered a particular zone or region within the passenger compartment and/or positioned an object within that zone or region.

For example, referring to FIG. 5B, the passenger compartment 520 includes a restricted zone 524 (e.g., the region of the passenger compartment 520 corresponding to the driver seat 522a). In some implementations, the restricted zone 524 includes the three-dimensional region of the passenger compartment 520 corresponding to the driver seat 522a (e.g., including the region where a person would occupy if she were to sit in the driver seat 552a), and exclude the other regions of the passenger compartment 520 (e.g., the region corresponding to the passengers seats seat 522b-522c and/or other regions).

During autonomous operations of the autonomous vehicle, passengers are restricted from entering the restricted zone 524 (e.g., such that the passengers do not interfere with the autonomous operations, such as by manipulating or otherwise interacting with the steering wheel, gear shift lever, turn signal lever, wiper lever, pedals, etc.). The passenger detection circuitry 504 determines, based on the sensor data 510, whether a passenger has entered the restricted zone 524 and/or moved an object within the restricted zone 524. For example, the passenger detection circuitry 504 determines, based on the sensor data 510, whether a passenger or object has breached or broken a “virtual fence” (e.g., a computer-generated boundary) separating the restricted zone from the rest of the passenger compartment 520.

Referring again to FIG. 5A, in some implementations, the passenger detection circuitry 504 is configured to determine the location of a passenger and/or object within the passenger compartment based on sensor data indicating the location of the passenger and/or object relative to one or more sensors. As an example, the sensor data includes depth or range information (e.g., indicating the distance of a passenger or object relative to a particular sensor) and/or angular information (e.g., indicating the angle of the passenger or object relative to the sensor).

As another example, the passenger detection circuitry 504 is configured to determine, based on the sensor data 510, whether a passenger is interacting with the control mechanisms for manually controlling the autonomous vehicle's operations (e.g., the steering wheel, gear shift lever, turn signal lever, wiper lever, pedals, etc.).

As another example, the passenger detection circuitry 504 is configured to determine, based on the sensor data 510, whether a passenger has secured a seat belt to her person (e.g., buckled or fastened the seat belt), or whether a passenger has removed the seat belt from her person (e.g., unbuckled or unfastened the seat belt).

In some embodiments the passenger detection circuitry 504 makes at least some of the determinations described herein based on one or more machine learning models. For example, a machine learning model is trained to receive input data (e.g., data received from the sensors 502), and, based on the input data, generate output data associated with one or more predictions regarding the characteristics and/or of one or more passengers of an autonomous vehicle.

As an example, a machine learning model is trained using training data 514 regarding one or more passengers, objects, etc. that are (or were) located in the passenger compartment of the vehicle 200 or another vehicle (e.g., training data stored in the database 410). These passengers and/or other objects include those that were previously detected and/or identified by the passenger detection system 210. These passengers and/or other objects also include those that were previously detected and/or identified by another system (e.g., another passenger detect system 210).

For each of the passengers and/or other objects, the training data includes input information similar to that described with reference to FIG. 4. For example, the training data includes sensor data obtained by one or more sensors (e.g., images, point clouds, sensor signals, etc.) that were generated while the passengers and/or other objects were located within the passenger compartment of a vehicle.

Further, for each of the passengers and/or other objects, the training data includes data representing the passenger's and/or other object's location within the passenger compartment.

Further, the training data includes data representing a classification or category of each of the passengers (e.g., whether each of the passenger is an adult or child).

Further, the training data includes data representing an identity of each of the passengers and/or other objects (e.g., whether it is a human, animal, inanimate object, etc.).

Further, the training data includes data representing whether the passenger and/or other object is in a particular region of the passenger compartment (e.g., in a restricted zone).

Further, the training data includes data representing whether each of the passengers has a seat belt secured to her person.

Further, the training data includes data representing whether each of the users is interacting with a control mechanism of the vehicle (e.g., the steering wheel, gear shift lever, turn signal lever, wiper lever, pedals, etc.

Based on the training data, the machine learning model is trained to identify correlations, relationships, and/or trends between (i) the input data, (ii) the characteristics of one or more passengers and/or other objects within a passenger compartment of a vehicle.

Example machine learning models are described in further detail with reference to FIGS. 6A-6C.

The passenger detection circuitry 504 and/or passenger data 512 representing the determined characteristics and behavior of one or more passengers within the passenger compartment 520, and transmits at least some of the passenger data 512 to the vehicle control circuitry 508.

In general, the vehicle control circuitry 508 generates one or more commands 518 for controlling (e.g., modifying) the operation of the autonomous vehicle based on the passenger data 512. The vehicle control circuitry 508 controls the operation of the autonomous vehicle differently, depending on the passenger's characteristics and/or behavior. For instance, if the passenger has certain characterizes and/or is behaving in a certain manner that increases a risk of injury and/or discomfort to the passenger, the vehicle control circuitry 508 modifies the operation of the autonomous vehicle to reduce that risk.

As an example, the passenger data 512 is evaluated (e.g., by the passenger detection circuitry 504) to determine that a passenger has entered the restricted zone 524 while the autonomous vehicle is in motion. Based on this determination, the vehicle control circuitry 508 generates a command 518 instructing the autonomous vehicle to reduce its speed and/or stop (e.g., by pulling over on a side of a road). Additionally or alternatively, the vehicle control circuitry 508 generates a command 518 instructing the autonomous vehicle to activate a hazard signal (e.g., to increase a visibility of the autonomous vehicle to others).

As another example, the passenger data 512 is evaluated (e.g., by the passenger detection circuitry 504) to determine that a passenger has removed a seat belt from her person while the autonomous vehicle is in motion. Based on this determination, the vehicle control circuitry 508 generates a command 518 instructing the autonomous vehicle to reduce its speed and/or stop (e.g., by pulling over on a side of a road). Additionally or alternatively, the vehicle control circuitry 508 generates a command 518 instructing the autonomous vehicle to activate a hazard signal (e.g., to increase a visibility of the autonomous vehicle to others).

As another example, the passenger data 512 is evaluated (e.g., by the passenger detection circuitry 504) to determine that a passenger has left her seat while the autonomous vehicle is in motion. Based on this determination, the vehicle control circuitry 508 generates a command 518 instructing the autonomous vehicle to reduce its speed and/or stop (e.g., by pulling over on a side of a road). Additionally or alternatively, the vehicle control circuitry 508 generates a command 518 instructing the autonomous vehicle to activate a hazard signal (e.g., to increase a visibility of the autonomous vehicle to others).

As another example, the passenger data 512 is evaluated (e.g., by the passenger detection circuitry 504) to determine that a passenger is manipulating, applying an external input, or otherwise interacting with the control mechanism of the autonomous vehicle (e.g., steering wheel, pedals, turn signal lever, gear shift lever, wiper lever, etc.) while the autonomous vehicle is in motion. Based on this determination, the vehicle control circuitry 508 generates a command 518 instructing the autonomous vehicle to reduce its speed and/or stop (e.g., by pulling over on a side of a road). Additionally or alternatively, the vehicle control circuitry 508 generates a command 518 instructing the autonomous vehicle to activate a hazard signal (e.g., to increase a visibility of the autonomous vehicle to others).

In some implementations, the vehicle control circuitry 508 generates a command 518 instructing the autonomous vehicle to selectively disable certain user-accessible mechanisms of the autonomous vehicle, depending on the characteristics of the passenger.

For example, the passenger data 512 is evaluated (e.g., by the passenger detection circuitry 504) to determine that a passenger that is occupying a particular seat of the autonomous vehicle is a child. Based on this determination, the vehicle control circuitry 508 generates a command 518 instructing the autonomous vehicle to selectively disable a window control mechanism for controlling the opening and/or closing of a window by the seat (e.g., the window or windows nearest to the seat). Additionally or alternatively, the vehicle control circuitry 508 generates a command 518 instructing the autonomous vehicle to selectively disable a door mechanism for opening and/or closing of a vehicle door by the seat (e.g., the door or doors nearest to the seat)

Further, the vehicle control circuitry 508 generates a command 518 instructing the autonomous vehicle to notify one or more passengers of the autonomous vehicle that the window control mechanism and/or the door mechanism have been disabled for that particular door or window. In some implementations, the autonomous vehicle alerts the passenger(s) by generating an audio notification (e.g., warning tone, voice alert, etc.), visual alert (e.g., warning light, graphical content displayed on a display screen, etc.), and/or a haptic alert (e.g., a vibration or pulse).

In some implementations, the passenger detection circuitry 504 can determine whether a passenger is a child or an adult based at least in part on a weight of the passenger (e.g., as determined by one or more passenger occupancy detection sensor(s)), images and/or point clouds of the of the passenger (e.g., obtained by one or more cameras, LiDAR sensors, ultrasonic sensors, radar sensors, time of flight sensors, etc.), manual input provided by the passenger herself or other passengers of the autonomous vehicle, and/or any combination thereof.

In some implementations, the passenger detection system 210 generates a series of commands to control the operation of the autonomous vehicle based on the detection of certain characteristics and/or behavior of the passenger(s) of an autonomous vehicle over time. As an example, FIG. 5C shows a process 550 for controlling the operation of an autonomous vehicle.

According to the process 550, the passenger detection system 210 determines that one or more passengers have entered the autonomous vehicle (block 552) (e.g., using the sensors 502 and the passenger detection circuitry 504).

Further, the passenger detection system 210 determines whether one or more of the passenger seats of the autonomous vehicle are occupied and whether the corresponding seat belt(s) have been fastened or buckled (block 554). This determination is performed, for example, using the sensors 502 and the passenger detection circuitry 504. The passenger detection system 210 instructs the autonomous vehicle to refrain from driving (block 556) until both of these conditions are detected.

Upon detecting that one or more of the passenger seats of the autonomous vehicle are occupied and whether the corresponding seat belt(s) have been fastened or buckled, the passenger detection system 210 instructs the autonomous vehicle to begin driving to a destination (block 558).

As the autonomous vehicle traverses to the destination (e.g., while the autonomous vehicle is in motion), the passenger detection system 210 determines whether a passenger and/or another object has entered a restricted zone of the autonomous vehicle (block 560). This determination is performed, for example, using the sensors 502 and the passenger detection circuitry 504. As described with reference to FIG. 5B, the restricted zone of an autonomous vehicle can refer to a region of the autonomous vehicle's passenger compartment corresponding to the driver's area (e.g., the area in and around the driver's seat).

If the passenger detection system 210 determines that a passenger and/or another object has not entered a restricted zone of the autonomous vehicle, the passenger detection system 210 instructs the autonomous vehicle to continue normal driving operation to the destination (block 562). As an example, during normal driving operation, the autonomous vehicle proceeds to the destination according to a particular default speed. During normal driving operation, a planning system (e.g., planning system 404 of FIG. 4) performs tactical function-related tasks to operate the autonomous vehicle in on-road traffic. Further, the passenger detection system 210 continues to check whether a passenger and/or another object has entered a restricted zone of the autonomous vehicle (e.g., continuously, periodically, intermittently, etc.).

If the passenger detection system 210 determines that a passenger and/or another object has entered a restricted zone of the autonomous vehicle, the passenger detection system 210 instructs the autonomous vehicle to (i) present an alert to the passenger(s), (ii) decrease the speed of the autonomous vehicle, and (iii) search for a safe location for the autonomous vehicle to pull over (block 564).

In some implementations, the autonomous vehicle alerts the passenger(s) by generating an audio notification (e.g., warning tone, voice alert, etc.), visual alert (e.g., warning light, graphical content displayed on a display screen, etc.), and/or a haptic alert (e.g., a vibration or pulse). The alert includes, for example, a warning to the passenger(s) that the autonomous will stop moving unless the passenger exits the restricted area and/or removes an object from the restricted area. Additionally and/or alternatively, the autonomous vehicle activates a hazard signal of the autonomous vehicle.

Further, the detection system 210 determines whether the passenger and/or object has exited the restricted zone within a threshold period of time (block 566). As an example, the threshold period of time is 1 second, 2 seconds, 3 second, or any other period of time.

If the passenger and/or object has exited the restricted zone within the threshold period of time, the passenger detection system 210 instructs the autonomous vehicle to continue normal driving operation to the destination (block 562).

If the passenger and/or object has not exited the restricted zone within the threshold period of time, the passenger detection system 210 determines whether a passenger has left her seat and/or has unfastened her seat belt (block 568). This determination is performed, for example, using the sensors 502 and the passenger detection circuitry 504.

If a passenger has left her seat and/or has unfastened her seat belt, the passenger detection system 210 instructs the autonomous vehicle to pull over and stop (block 570). In some implementations, the passenger detection system 210 instructs the autonomous vehicle to pull over and stop immediately upon determining that a passenger has left her seat and/or has unfastened her seat belt. In some implementations, the passenger detection system 210 instructs the autonomous vehicle to pull over and stop after a pre-determined period of time has elapsed after the detection.

If a passenger has not left her seat and/or has unfastened her seat belt, the passenger detection system 210 determines whether an external input has been applied to a control mechanisms of the autonomous vehicle (e.g., steering wheel, pedals, turn signal lever, gear shift lever, wiper lever, etc.) (block 572). This determination is performed, for example, using the sensors 502 and the passenger detection circuitry 504.

If an external input has been applied to the control mechanisms of the autonomous vehicle, the passenger detection system 210 instructs the autonomous vehicle to pull over and stop (block 570). In some implementations, the passenger detection system 210 instructs the autonomous vehicle to pull over and stop immediately upon determining that an external input has been applied to a control mechanisms of the autonomous vehicle. In some implementations, the passenger detection system 210 instructs the autonomous vehicle to pull over and stop after a pre-determined period of time has elapsed after the detection.

In some implementations, the autonomous vehicle generates notifications, slows down the vehicle, and/or pulls over and stops the vehicle according to a time-delayed sequence.

For instance, in some implementations, the autonomous vehicle generates a notification upon determining that a passenger and/or an object entered the restricted zone and has remained in the restricted zone for a first threshold period of time. As an example, the autonomous vehicle generates a notification upon determining that a passenger and/or an object entered the restricted zone and has remained in the restricted zone for 1 second.

Further, some implementations, the autonomous vehicle begins decreasing the speed of the autonomous vehicle upon determining that the passenger and/or the object has not exited the restricted zone within a second threshold period of time after the generation of the notification. As an example, the autonomous vehicle begins decreasing the speed of the autonomous vehicle upon determining that the passenger and/or the object has not exited the restricted zone within 1.5 seconds after the generation of the notification.

Further, in some implementations, the autonomous vehicle immediately pulls over and stops the vehicle upon determining that an external input has been provided to a control mechanism of the autonomous vehicle (e.g., steering wheel, pedals, turn signal, lever, gear shift lever, wiper lever, etc.).

Although example threshold periods of time are described herein, in practice, other threshold periods of time can be used. For instance, each of the threshold periods of time can be tunable values that are selected based on experimental tests (e.g., experimental tests that identify specific threshold periods of time that improve passenger safety, passenger comfort, vehicle performance, and/or vehicle efficiency).

In some aspects and/or embodiments, systems, methods, and computer program products described herein include and/or implement controlling an operation of an autonomous vehicle based on detected passenger characteristics and behavior.

In an example implementation, a passenger detection system detects a passenger performing certain actions while an autonomous vehicle is moving. Example actions including entering a restricted zone of the passenger compartment (e.g., an region of the passenger compartment corresponding to the driver's area), introducing an object into the restricted zone, and/or manipulating the control mechanisms of the autonomous vehicle (e.g., steering wheel, pedals, turn signal lever, gear shift lever, wiper lever, etc.). In response, the passenger detection system modifies an operation of the autonomous vehicle. Example modifications include presenting a warning notification to the passenger, reducing the speed of the autonomous vehicle, turning on a hazard signal of the autonomous vehicle, and/or stopping the autonomous vehicle (e.g., by pulling over the autonomous vehicle on a side of a road).

In another example implementation, a passenger detection system detects the presence of a passenger in a particular seat of the autonomous vehicle, and determines whether the passenger is an adult or a child. Upon determining that the passenger is a child, the passenger detection system selectively disables certain control mechanisms that may be accessible by that passenger. As an example, the passenger detection system disables mechanisms for opening a door and/or a window near the passenger.

Some of the advantages of these implementations include increasing the safety of an autonomous vehicle. For example, a passenger detection system detects behavior by a passenger that may interfere with the safe of operation of the autonomous vehicle, and perform operations that reduce a risk of the autonomous vehicle being involved in a traffic conflict and/or reduce the risk that the passenger being injured.

Further, a passenger detection system is used in lieu of a physical barrier (e.g., a plastic wall) to prevent a passenger from accessing a restricted zone of an autonomous vehicle, which may be undesirable in some implementations. For example, in some implementations, a physical barrier introduces a safety risk to a passenger (e.g., as the passenger may come into contact with the physical barrier during a sudden maneuver by the autonomous vehicle). As another example, in some implementations, a physical barrier may reduce the seating capacity of the autonomous vehicle and/or reduce the space that is available to a passenger. Accordingly, an autonomous vehicle having a passenger detection system in lieu of a physical barrier may operate more safety, provide increased seating capacity, and/or provide increased passenger comfort when compared to an autonomous vehicle that includes a physical barrier to protect a restricted zone. Nevertheless, in some implementations, a passenger detection system is used in combination with a physical barrier to prevent a passenger from accessing a restricted zone of an autonomous vehicle (e.g., to further protect the restricted zone of the autonomous vehicle during operation).

Referring now to FIG. 6A, illustrated is a diagram of an implementation of a machine learning model. More specifically, illustrated is a diagram of an implementation of a convolutional neural network (CNN) 620. For purposes of illustration, the following description of CNN 620 will be with respect to an implementation of CNN 620 by the passenger detection system 210. However, it will be understood that in some examples CNN 620 (e.g., one or more components of CNN 620) is implemented by other systems different from, or in addition to, the passenger detection system 210, such as the perception system 402, planning system 404, localization system 406, and/or control system 408. While CNN 620 includes certain features as described herein, these features are provided for the purpose of illustration and are not intended to limit the present disclosure.

CNN 620 includes a plurality of convolution layers including first convolution layer 622, second convolution layer 624, and convolution layer 626. In some embodiments, CNN 620 includes sub-sampling layer 628 (sometimes referred to as a pooling layer). In some embodiments, sub-sampling layer 628 and/or other subsampling layers have a dimension (i.e., an amount of nodes) that is less than a dimension of an upstream system. By virtue of sub-sampling layer 628 having a dimension that is less than a dimension of an upstream layer, CNN 620 consolidates the amount of data associated with the initial input and/or the output of an upstream layer to thereby decrease the amount of computations necessary for CNN 620 to perform downstream convolution operations. Additionally, or alternatively, by virtue of sub-sampling layer 628 being associated with (e.g., configured to perform) at least one subsampling function (as described below with respect to FIGS. 6B and 6C), CNN 620 consolidates the amount of data associated with the initial input.

The passenger detection system 210 performs convolution operations based on passenger detection system 210 providing respective inputs and/or outputs associated with each of first convolution layer 622, second convolution layer 624, and convolution layer 626 to generate respective outputs. In some examples, the passenger detection system 210 implements CNN 620 based on the passenger detection system 210 providing data as input to first convolution layer 622, second convolution layer 624, and convolution layer 626. In such an example, the passenger detection system 210 provides the data as input to first convolution layer 622, second convolution layer 624, and convolution layer 626 based on the passenger detection system 210 receiving data from one or more sensors (e.g., the sensors 502). A detailed description of convolution operations is included below with respect to FIG. 6B.

In some embodiments, the passenger detection system 210 provides data associated with an input (referred to as an initial input) to first convolution layer 622 and the passenger detection system 210 generates data associated with an output using first convolution layer 622. In some embodiments, provides an output generated by a convolution layer as input to a different convolution layer. For example, the passenger detection system 210 provides the output of first convolution layer 622 as input to sub-sampling layer 428, second convolution layer 624, and/or convolution layer 626. In such an example, first convolution layer 622 is referred to as an upstream layer and sub-sampling layer 628, second convolution layer 624, and/or convolution layer 626 are referred to as downstream layers. Similarly, in some embodiments, the passenger detection system 210 provides the output of sub-sampling layer 628 to second convolution layer 624 and/or convolution layer 626 and, in this example, sub-sampling layer 628 would be referred to as an upstream layer and second convolution layer 624 and/or convolution layer 626 would be referred to as downstream layers.

In some embodiments, the passenger detection system 210 processes the data associated with the input provided to CNN 620 before the passenger detection system 210 provides the input to CNN 620. For example, the passenger detection system 210 processes the data associated with the input provided to CNN 620 based on the passenger detection system 210 normalizing sensor data (e.g., image data, LiDAR data, radar data, sensor signals, and/or the like).

In some embodiments, CNN 620 generates an output based on the passenger detection system 210 performing convolution operations associated with each convolution layer. In some examples, CNN 620 generates an output based on the passenger detection system 210 performing convolution operations associated with each convolution layer and an initial input. In some embodiments, the passenger detection system 210 generates the output and provides the output as fully connected layer 630. In some examples, the passenger detection system 210 provides the output of convolution layer 626 as fully connected layer 630, where fully connected layer 630 includes data associated with a plurality of feature values referred to as F1, F2 . . . FN. In this example, the output of convolution layer 626 includes data associated with a plurality of output feature values that represent a prediction.

In some embodiments, the passenger detection system 210 identifies a prediction from among a plurality of predictions based on the passenger detection system 210 identifying a feature value that is associated with the highest likelihood of being the correct prediction from among the plurality of predictions. For example, where fully connected layer 630 includes feature values F1, F2, . . . FN, and F1 is the greatest feature value, the passenger detection system 210 identifies the prediction associated with F1 as being the correct prediction from among the plurality of predictions. In some embodiments, the passenger detection system 210 trains CNN 620 to generate the prediction. In some examples, the passenger detection system 210 trains CNN 620 to generate the prediction based on the passenger detection system 210 providing training data associated with the prediction to CNN 620.

Referring now to FIGS. 6B and 6C, illustrated is a diagram of example operation of CNN 640 by the passenger detection system 210 (e.g., the passenger detection circuitry 504). In some embodiments, CNN 640 (e.g., one or more components of CNN 640) is the same as, or similar to, CNN 620 (e.g., one or more components of CNN 620) (see FIG. 6A).

At step 650, the passenger detection system 210 provides data associated with sensor data (e.g., images, point clouds, sensor signals, etc.) as input to CNN 640 (step 650). For example, as illustrated, the passenger detection system 210 provides the data associated with the image to CNN 640, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 655, CNN 640 performs a first convolution function. For example, CNN 640 performs the first convolution function based on CNN 640 providing the values representing the image as input to one or more neurons (not explicitly illustrated) included in first convolution layer 642. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 640 performs the first convolution function based on CNN 640 multiplying the values provided as input to each of the one or more neurons included in first convolution layer 642 with the values of the filter that corresponds to each of the one or more neurons. For example, CNN 640 can multiply the values provided as input to each of the one or more neurons included in first convolution layer 642 with the values of the filter that corresponds to each of the one or more neurons to generate a single value or an array of values as an output. In some embodiments, the collective output of the neurons of first convolution layer 642 is referred to as a convolved output. In some embodiments, where each neuron has the same filter, the convolved output is referred to as a feature map.

In some embodiments, CNN 640 provides the outputs of each neuron of first convolutional layer 642 to neurons of a downstream layer. For purposes of clarity, an upstream layer can be a layer that transmits data to a different layer (referred to as a downstream layer). For example, CNN 640 can provide the outputs of each neuron of first convolutional layer 642 to corresponding neurons of a subsampling layer. In an example, CNN 640 provides the outputs of each neuron of first convolutional layer 642 to corresponding neurons of first subsampling layer 644. In some embodiments, CNN 640 adds a bias value to the aggregates of all the values provided to each neuron of the downstream layer. For example, CNN 640 adds a bias value to the aggregates of all the values provided to each neuron of first subsampling layer 644. In such an example, CNN 640 determines a final value to provide to each neuron of first subsampling layer 644 based on the aggregates of all the values provided to each neuron and an activation function associated with each neuron of first subsampling layer 644.

At step 660, CNN 440 performs a first subsampling function. For example, CNN 640 can perform a first subsampling function based on CNN 640 providing the values output by first convolution layer 642 to corresponding neurons of first subsampling layer 644. In some embodiments, CNN 640 performs the first subsampling function based on an aggregation function. In an example, CNN 640 performs the first subsampling function based on CNN 640 determining the maximum input among the values provided to a given neuron (referred to as a max pooling function). In another example, CNN 640 performs the first subsampling function based on CNN 640 determining the average input among the values provided to a given neuron (referred to as an average pooling function). In some embodiments, CNN 640 generates an output based on CNN 640 providing the values to each neuron of first subsampling layer 644, the output sometimes referred to as a subsampled convolved output.

At step 665, CNN 640 performs a second convolution function. In some embodiments, CNN 640 performs the second convolution function in a manner similar to how CNN 640 performed the first convolution function, described above. In some embodiments, CNN 640 performs the second convolution function based on CNN 640 providing the values output by first subsampling layer 644 as input to one or more neurons (not explicitly illustrated) included in second convolution layer 646. In some embodiments, each neuron of second convolution layer 646 is associated with a filter, as described above. The filter(s) associated with second convolution layer 646 may be configured to identify more complex patterns than the filter associated with first convolution layer 642, as described above.

In some embodiments, CNN 640 performs the second convolution function based on CNN 640 multiplying the values provided as input to each of the one or more neurons included in second convolution layer 646 with the values of the filter that corresponds to each of the one or more neurons. For example, CNN 640 can multiply the values provided as input to each of the one or more neurons included in second convolution layer 646 with the values of the filter that corresponds to each of the one or more neurons to generate a single value or an array of values as an output.

In some embodiments, CNN 640 provides the outputs of each neuron of second convolutional layer 646 to neurons of a downstream layer. For example, CNN 640 can provide the outputs of each neuron of first convolutional layer 642 to corresponding neurons of a subsampling layer. In an example, CNN 640 provides the outputs of each neuron of first convolutional layer 642 to corresponding neurons of second subsampling layer 648. In some embodiments, CNN 640 adds a bias value to the aggregates of all the values provided to each neuron of the downstream layer. For example, CNN 640 adds a bias value to the aggregates of all the values provided to each neuron of second subsampling layer 648. In such an example, CNN 640 determines a final value to provide to each neuron of second subsampling layer 648 based on the aggregates of all the values provided to each neuron and an activation function associated with each neuron of second subsampling layer 648.

At step 670, CNN 640 performs a second subsampling function. For example, CNN 640 can perform a second subsampling function based on CNN 640 providing the values output by second convolution layer 646 to corresponding neurons of second subsampling layer 648. In some embodiments, CNN 640 performs the second subsampling function based on CNN 640 using an aggregation function. In an example, CNN 640 performs the first subsampling function based on CNN 640 determining the maximum input or an average input among the values provided to a given neuron, as described above. In some embodiments, CNN 440 generates an output based on CNN 640 providing the values to each neuron of second subsampling layer 648.

At step 675, CNN 640 provides the output of each neuron of second subsampling layer 648 to fully connected layers 649. For example, CNN 640 provides the output of each neuron of second subsampling layer 648 to fully connected layers 649 to cause fully connected layers 649 to generate an output. In some embodiments, fully connected layers 649 are configured to generate an output associated with a prediction (sometimes referred to as a classification). The prediction may include an indication that an object included in the image provided as input to CNN 640 includes an object, a set of objects, and/or the like. In some embodiments, the passenger detection system 210 performs one or more operations and/or provides the data associated with the prediction to a different system, described herein.

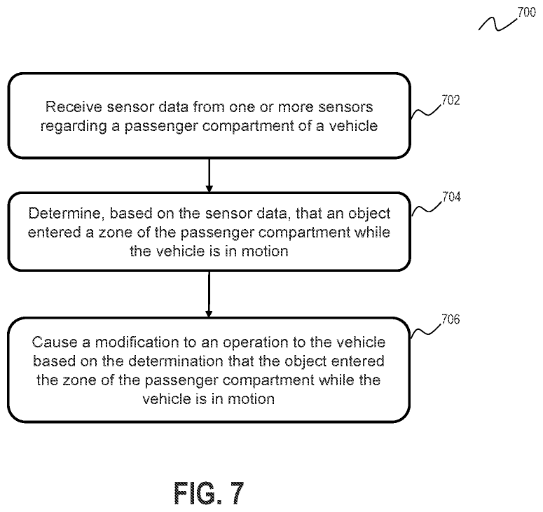

Referring now to FIG. 7, illustrated is a flowchart of a process 700 for controlling the operation of an autonomous vehicle based on detected passenger characteristics and behavior. In some embodiments, one or more of the steps described with respect to process 700 are performed (e.g., completely, partially, and/or the like) by one or more components of an autonomous vehicle, such as one or more processors that implement the passenger detection system 210 shown in FIGS. 2, 5, and 6. Additionally, or alternatively, in some embodiments one or more steps described with respect to process 700 are performed (e.g., completely, partially, and/or the like) by another device or group of devices separate from an autonomous vehicle, such as by one or more processors of a remote computer system (e.g., a remote AV system 114, fleet management system 116, V2I system 118, etc.).

According to the process 700, one or more processors receive sensor data from one or more sensors regarding a passenger compartment of a vehicle (block 702).

In some implementations, receiving the sensor data from the one or more sensors regarding the passenger compartment of the vehicle includes receiving at least a portion of the sensor data from comprise a camera.

In some implementations, receiving the sensor data from the one or more sensors regarding the passenger compartment of the vehicle includes receiving at least a portion of the sensor data from at least one of a seat occupancy sensor, or a seat belt sensor.

Further, the one or more processors determine, based on the sensor data, that an object entered a zone of the passenger compartment while the vehicle is in motion (block 704).

In some implementations, the zone corresponds to a driver area of the passenger compartment.

In some implementations, the passenger compartment includes a driver seat and one or more passenger seats. Further, the zone includes the driver seat and excludes the one or more passenger seats.

In some implementations, determining that the object entered the zone of the of the passenger compartment while the vehicle is in motion includes determining that at least one of a person, an animal, or an inanimate object entered the zone of the passenger compartment while the vehicle is in motion.

Further, the one or more processors cause a modification to an operation to the vehicle based on the determination that the object entered the zone of the passenger compartment while the vehicle is in motion (block 706).

In some implementations, causing the modification to the operation of the vehicle includes causing the vehicle to decrease in speed.

In some implementations, causing the modification to the operation of the vehicle includes causing the vehicle is activate a hazard signal of the vehicle.

In some implementations, causing the modification to the operation of the vehicle includes causing the vehicle to stop.

In some implementations, the process 700 also includes determining, based on the sensor data, that the object has remained in the zone of the passenger compartment for a period of time greater than a threshold period of time. Further, causing the modification to the operation to the vehicle is further based on the determination that the object has remained in the zone of the passenger compartment for a period of time greater than the threshold period of time.

In some implementations, the process 700 also includes determining that a passenger of the vehicle has at least one of (i) moved from a passenger seat of the vehicle while the vehicle is in motion or (ii) unbuckled a seat belt while the vehicle is in motion. Further, causing the modification to the operation to the vehicle is further based on the determination that the passenger of the vehicle has at least one of (i) moved from the passenger seat of the vehicle while the vehicle is in motion or (ii) unbuckled the seat belt while the vehicle is in motion.

In some implementations, the process 700 also includes determining that a manual input has been applied to a control mechanism of the vehicle. Further, causing the modification to the operation to the vehicle is further based on the determination that the manual input has been applied to the control mechanism of the vehicle.

In some implementations, the process 700 also includes determining that the manual input has been applied to the control mechanism of the vehicle includes determining that the manual input has been applied to at least one of a steering wheel of the vehicle, a pedal of the vehicle, a signal lever of the vehicle, or a wiper lever of the vehicle.

In some implementations, the vehicle is stopped based on (1) a determination that the object has remained in the zone of the passenger compartment for a period of time greater than a threshold period of time, (2) the determination that the passenger of the vehicle has at least one of (i) moved from a seat of the vehicle while the vehicle is in motion or (ii) unbuckled a seat belt while the vehicle is in motion, and (3) the determination that a manual input has been applied to a control mechanism of the vehicle.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
receiving, by one or more processors, sensor data from one or more sensors regarding a passenger compartment of a vehicle;
determining, by the one or more processors, and based on the sensor data, that an object entered a zone of the passenger compartment while the vehicle is in motion; and
causing, by the one or more processors, a modification to an operation to the vehicle based on the determination that the object entered the zone of the passenger compartment while the vehicle is in motion.

2. The method of claim 1, wherein the zone corresponds to a driver area of the passenger compartment.

3. The method of claim 1, wherein the passenger compartment comprises a driver seat and one or more passenger seats, and
wherein the zone comprises the driver seat and excludes the one or more passenger seats.

4. The method of claim 1, wherein determining that the object entered the zone of the of the passenger compartment while the vehicle is in motion comprises:
determining that at least one of a person, an animal, or an inanimate object entered the zone of the passenger compartment while the vehicle is in motion.

5. The method of claim 1, wherein causing the modification to the operation of the vehicle comprises causing the vehicle to decrease in speed.

6. The method of claim 1, wherein causing the modification to the operation of the vehicle comprises causing the vehicle is activate a hazard signal of the vehicle.

7. The method of claim 1, wherein causing the modification to the operation of the vehicle comprises causing the vehicle to stop

8. The method of claim 1, wherein receiving the sensor data from the one or more sensors regarding the passenger compartment of the vehicle comprises:
receiving at least a portion of the sensor data from comprise a camera.

9. The method of claim 1, wherein receiving the sensor data from the one or more sensors regarding the passenger compartment of the vehicle comprises:
receiving at least a portion of the sensor data from at least one of a seat occupancy sensor, or a seat belt sensor.

10. The method of claim 1, further comprising:
determining, based on the sensor data, that the object has remained in the zone of the passenger compartment for a period of time greater than a threshold period of time, and
wherein causing the modification to the operation to the vehicle is further based on the determination that the object has remained in the zone of the passenger compartment for a period of time greater than the threshold period of time.

11. The method of claim 1, further comprising:
determining that a passenger of the vehicle has at least one of (i) moved from a passenger seat of the vehicle while the vehicle is in motion or (ii) unbuckled a seat belt while the vehicle is in motion, and
wherein causing the modification to the operation to the vehicle is further based on the determination that the passenger of the vehicle has at least one of (i) moved from the passenger seat of the vehicle while the vehicle is in motion or (ii) unbuckled the seat belt while the vehicle is in motion.

12. The method of claim 1, further comprising:
determining that a manual input has been applied to a control mechanism of the vehicle, and
wherein causing the modification to the operation to the vehicle is further based on the determination that the manual input has been applied to the control mechanism of the vehicle.

13. The method of claim 12, wherein determining that the manual input has been applied to the control mechanism of the vehicle comprises:
determining that the manual input has been applied to at least one of a steering wheel of the vehicle, a pedal of the vehicle, a signal lever of the vehicle, or a wiper lever of the vehicle.

14. The method of claim 1, wherein the modification to the operation of the vehicle comprises stopping the vehicle based on:
a determination that the object has remained in the zone of the passenger compartment for a period of time greater than a threshold period of time,
the determination that the passenger of the vehicle has at least one of (i) moved from a seat of the vehicle while the vehicle is in motion or (ii) unbuckled a seat belt while the vehicle is in motion, and
the determination that a manual input has been applied to a control mechanism of the vehicle.

15. A system, comprising:
at least one processor, and
at least one non-transitory storage media storing instructions that, when executed by the at least one processor, cause the at least one processor to:
receive sensor data from one or more sensors regarding a passenger compartment of a vehicle;
determine, based on the sensor data, that an object entered a zone of the passenger compartment while the vehicle is in motion; and
cause a modification to an operation to the vehicle based on the determination that the object entered the zone of the passenger compartment while the vehicle is in motion.

16. At least one non-transitory storage media storing instructions that, when executed by at least one processor, cause the at least one processor to:
receive sensor data from one or more sensors regarding a passenger compartment of a vehicle;
determine, based on the sensor data, that an object entered a zone of the passenger compartment while the vehicle is in motion; and
cause a modification to an operation to the vehicle based on the determination that the object entered the zone of the passenger compartment while the vehicle is in motion.
